(19) United States
(12) Patent Application Publication
(10) Pub. No.: US 2024/0291020 A1
(43) Pub. Date: Aug. 29, 2024

(54) COMPOSITE MATERIAL COMPRISING A FLUORINATED AMIDE AND USES THEREOF IN ELECTROCHEMICAL CELLS

(71) Applicant: HYDRO-QUÉBEC, Montréal (CA)

(72) Inventors: Xuewei ZHANG, Saint-Hubert (CA); Jean-Christophe DAIGLE, St-Bruno-de-Montarville (CA); Chisu KIM, Longueuil (CA)

(21) Appl. No.: 18/569,864

(22) PCT Filed: Jun. 17, 2022
(86) PCT No.: PCT/CA2022/050978

§ 371 Date: Dec. 13, 2023

(30) Foreign Application Priority Data
Jun. 18, 2021 (CA) 3,122,820

(51) Int. Cl. H01M 10/056; H01M 4/02; H01M 4/36; H01M 4/40; H01M 4/62; H01M 10/0525

(52) U.S. Cl. CPC H01M 10/056; H01M 4/366; H01M 4/405; H01M 4/622; H01M 4/625; H01M 10/0525; H01M 2004/027; H01M 2004/028; H01M 2300/0091

(57) ABSTRACT

The present technology relates to a composite material comprising inorganic particles, a fluorinated amide compound, and optionally an electrolyte polymer, plasticizer and/or salt, as well as to the process for preparing the composite material. Also described are solid electrolytes and electrode materials comprising the present composite material and their use in electrochemical cells and accumulators comprising them.

### RELATED APPLICATION

This application claims priority under applicable law to Canadian patent application number 3,122,820 filed on Jun. 18, 2021, the content of which is incorporated herein by reference in its entirety and for all purposes.

### TECHNICAL FIELD

The present application relates to polymer-ceramic composite electrolytes comprising an organic additive, to their manufacturing processes and to electrochemical cells comprising them.

### BACKGROUND

Lithium ion-conducting polymer electrolytes enable the development of safer and more affordable manufacturing processes, which are easily scaled up for large-format all-solid-state batteries (for example, see U.S. Pat. No. 6,903,174).

However, low ionic conductivity limits its application at room temperature and results in relatively low charge/discharge rates compared with conventional lithium-ion batteries.

On the other hand, solid inorganic electrolytes are promising candidates for solid-state batteries, as they provide higher lithium ion conductivity that is comparable to liquid electrolytes. In addition, the unique ion conduction property of inorganic electrolytes enables a lower concentration polarization at the lithium metal interface, allowing high-speed battery charging and discharging. Despite its high ionic conductivity in the densified mass phase, complete cells using ceramic solid electrolytes suffer from poor electrochemical performance due to significant interface resistance at the grain boundaries of the ceramic particles and between the particles of composite electrodes made from a mixture of active material particles, carbon additive and solid electrolyte. As Li+ ion conduction must be carried out in particle-to-particle mode, the electrochemical performance is limited by the poor distribution of solid electrolyte particles as well as by the presence of voids between particles.

A recent review of various composite type electrolytes, comprising a polymer and solide electrolyte particles, was published by the group of S. Tang et al. (Adv. Energy Mater., 2021, 11, 2000802 (pages 1 to 29)). In order to improve ionic conductivity, various organic solvents (such as carbonate esters) and other plasticizers (such as 1-propene-1,3-sultone, glycerine, tetraethylene glycol dimethyl ether (TEGDME) or hexafluoropropylene (HFP)) can be added to the composite. These can, however, reduce the mechanical strength, for example, if present in excessive quantities. Electrochemical instability problems can also be encountered with these composite electrolytes, particularly at the interface between the electrolyte layer and one of the electrodes, such as a lithium metal electrode. In fact, according to Tang et al., despite the progresses achieved in composite electrolytes, these still face various challenges in terms of ionic conductivity, electrochemical stability, and interfacial interactions.

The team of Zhu et al. has also recently described some strategies that can be used to increase the ionic conductivity and interfacial compatibility of solid inorganic-organic composite electrolytes (see Energy Storage Materials, 2021, 36, 291-308). The strategies for increasing ionic conductivity include adjusting inorganic particle content, optimizing particle size and morphology, orienting the inorganic particles, modifying the surface of inorganic particles (e.g., with polydopamine, silanes, etc.), or adding additives such as plasticizers in the form of small molecules (such as succinonitrile, TEGDME, etc.). Strategies described for improving the interfacial compatibility of solid composite electrolytes include symmetrical or asymmetrical multilayer configurations, interactions between the polymer (such as polycaprolactone) and inorganic particles, mixtures of two different polymers (such as poly(ethylene oxide) (PEO) and boronized poly(ethylene glycol) (BPEG)) with the particles, and so on.

There is therefore a constant need for the development of solid electrolytes with the advantages generally associated therewith, while improving at least one of the above-mentioned aspects.

### SUMMARY

According to a first aspect, the present technology relates to a composite material comprising inorganic particles, a fluorinated compound, and optionally a polymer, the fluorinated compound being of Formula I:

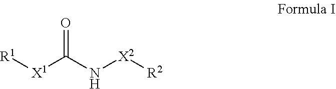

wherein:
R¹ and R² are independently at each occurrence selected from an optionally substituted linear or branched C¹-8alkyl group, an optionally substituted C₃₋₈cycloalkyl group, an optionally substituted C₆aryl group, an optionally substituted C₃₋₈heterocycloalkyl group, and an optionally substituted C₅₋₆heteroaryl group;
X¹ is selected from O and NH or X¹ is absent;
X² is selected from C(O), S(O)₂, and Si(R³R⁴), where R³ and R⁴ are independently at each occurrence an optionally substituted linear or branched C₁₋₈alkyl group, or X² is absent;
wherein at least one of R¹, R², R³ and R⁴ is a group substituted by one or more fluorine atoms.

According to one embodiment, X¹ is absent and X² is selected from C(O), S(O)₂, and Si(R³R⁴), or X¹ is selected from O and NH and X² is absent, or X¹ and X² are both absents.

According to another embodiment, R¹ is a group substituted by one or more fluorine atoms, for example, R¹ can be a perfluorinated group. In one embodiment, R¹ is a linear or branched C₁₋₈alkyl group, or a linear or branched C₁₋₄alkyl group, or a C₁₋₂alkyl group.

In some embodiments, R² is a group substituted by one or more fluorine atoms, for example, R² can be a perfluorinated group. According to one embodiment, R² is a linear or branched C₁₋₈alkyl group, or a linear or branched C₁₋₄alkyl group, or a C₁₋₂alkyl group. Alternatively, R² is an optionally substituted C₃₋₈cycloalkyl group, or an optionally substituted C₃₋₆cycloalkyl group, or an optionally substituted C₅₋₆cycloalkyle group.

In some embodiments, the fluorinated compound is selected from N-methyltrifluoroacetamide (NMTFAm), N-methylpentaproprionamide (NMPPPAm), N-cylcopentyltrifluoroacetamide (NCPTFAm), N-trifluoromethylsulfonyl trifluoroacetamide (NTFMSTFAm), N-trimethylsilyl trifluoroacetamide (NTMSTFAm), and bistrifluoroacetamide (BTFAm).

In one embodiment, the concentration of the compound in the composite material is within the range of 1% to 90% by weight, or 1% to 70% by weight, or 1% to 50% by weight, or 1% to 40% by weight, or 5% to 30% by weight, or 10% to 25% by weight, or 15% to 20% by weight.

In another embodiment, the polymer is present and may be a cross-linked aprotic polymer and/or a branched polymer, preferably of the multi-branch type. According to one embodiment, the polymer comprises at least one polymer segment selected from ionic conducting segments polyether, polythioether, polyester, polythioester, polycarbonate, polythiocarbonate, polyimide, polysulfonimide, polyamide, polysulfonamide, polyphosphazene, and the ionically non-conductive segments polyacrylate, polymethacrylate, polystyrene, polysiloxane, polyurethane, polyethylene, polypropylene, or a copolymer or combination of two or more thereof.

According to another embodiment, the polymer comprises at least one polymer segment comprising a block copolymer with at least two different repeating units in order to reduce the crystallinity of the crosslinked polymer, for example, the polymer segment comprising, prior to crosslinking, a block copolymer comprising at least one alkali metal or alkaline earth metal ion solvating segment and a crosslinkable segment comprising crosslinkable units. According to an embodiment, the alkali metal or alkaline earth metal ion solvating segment is selected from homo- and copolymers comprising repeating units of Formula II:

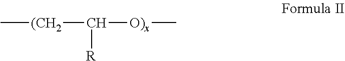

wherein,
R is selected from H, C₁-C₁₀alkyl, and —(CH₂—O—RₐR_{b});
Rₐ is (CH₂—CH₂—O)_{y}; and
R_{b} is a C₁-C₁₀alkyl group.

In one embodiment, the crosslinkable units comprise functional groups selected from acrylates, methacrylates, allyls, vinyls, hydroxides, epoxides, aldehydes, carboxylic acids, halophenyls, halobenzyls, alkynes, azides, amines, thiols and any combination thereof.

In some embodiments, the polymer is present in the composite material at a concentration in the range of 1% to 80% by weight, 5% to 70% by weight, or 10% to 50% by weight, or 20% to 40% by weight.

According to another embodiment, the inorganic particles comprise an inorganic compound of the amorphous, ceramic or glass-ceramic type, for example, oxide, sulfide or oxysulfide. Preferably, the inorganic compound of the amorphous, ceramic or glass-ceramic type is an oxide. In another embodiment, the inorganic particles comprise a ceramic selected from Al₂O₃, Mg₂B₂O₅, Na₂O·2B₂O₃, xMgO·yB₂O₃·ZH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., aluminosilicate, mesoporous silica), sulfide ceramics (such as Li₇P₃S₁₁), glass ceramics (e.g. LIPON, etc.), and other ceramics, as well as combinations thereof. Preferably, the ceramic is selected from Al₂O₃, Mg₂B₂O₅, Na₂O·2B₂O₃, xMgO·yB₂O₃ ZH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., aluminosilicate, mesoporous silica), glass ceramics (e.g. LIPON, etc.), and combinations thereof.

According to one embodiment, the inorganic particles are in the form of spherical particles, rods, needles, nanotubes, or one of their combinations.

According to one embodiment, the inorganic particles comprise a compound selected from the compounds of formula Li_{1+z}Al_{z}M_{2-z}(PO₄)₃, where M is Ti, Ge or a combination thereof, and 0<z<1, for example, where z can be within the range of 0.1 to 0.9, or of 0.3 to 0.7, or of 0.2 to 0.4.

In another embodiment, the inorganic particles comprise a compound selected from compounds of the formulae Li₇₋ₓLa₃Zr₂M^{x}ₓO₁₂ and Li_{3y}La_{(2/3)-y}Ti_{1-y′}M^{y}_{y′}O₃ wherein M^{x} is selected from Al, Ga, Ta, Fe, and Nb; M^{y} is selected from Ba, B, Al, Si, and Ta; x is such that 0≤x≤1; y is such that 0<y<0.67; and y′ is such that 0≤y′<1. For example, x may be within the range of 0 to 0.5, or x is zero and M^{x} is absent.

According to one embodiment, the inorganic particle content is in the range from 1% to 95% by weight, or from 5% to 90% by weight, or from 5% to 80% by weight, or from 5% to 70% by weight, or from 5% to 60% by weight, or from 5% to 50% by weight, or from 5% to 40% by weight, or from 5% to 25% by weight, or from 5% to 15% by weight.

According to another embodiment, the composite material comprises the polymer and additionally a plasticizing agent. For example, the plasticizing agent may be selected from liquid glycol diethers (such as tetraethylene glycol dimethyl ether (TEGDME)), carbonate esters, ionic liquids, and the like. In one embodiment, the plasticizing agent may be present in the composite material at a concentration in the range of 0.1% to 50% by weight, or of 10% to 50% by weight, or of 20% to 40% by weight.

According to another embodiment, the composite material further comprises a salt. For example, the salt may comprise a cation of an alkali or alkaline earth metal, preferably an alkali metal (preferably Li), and an anion selected from hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imidure (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato(2-)—O,O′)borate [B(C₆O₂)₂]⁻ (BBB⁻), difluoro(oxalato)borate (BF₂(C₂O₄)⁻) (FOB⁻), an anion of the formula BF₂O₄Rₓ⁻ (where Rₓ=C₂₋₄alkyl), and one of their combinations, for example LiTFSI or LiFSI.

According to a second aspect, the present document relates to a solid electrolyte comprising a layer of the composite material as herein defined.

According to a third aspect, the present technology relates to an electrochemical cell comprising a negative electrode, a positive electrode, and a solid electrolyte, wherein at least one of the positive electrode, the negative electrode, and the electrolyte comprises a composite material as herein defined. According to one embodiment, the electrochemical cell comprises a negative electrode, a positive electrode, and a solid electrolyte, wherein the solid electrolyte is as herein defined. According to another embodiment, the solid electrolyte is as herein defined and at least one of the negative electrode and the positive electrode comprises a composite material as herein defined.

According to one embodiment, the positive electrode comprises a positive electrode material optionally on a current collector, wherein the positive electrode material comprises a positive electrode electrochemically active material. According to another embodiment, the positive electrode electrochemically active material is selected from metal phosphates, lithiated metal phosphates, metal oxides, and lithiated metal oxides. According to yet another embodiment, the positive electrode electrochemically active material is LiM′PO₄ where M′ is Fe, Ni, Mn, Co, or a combination thereof, LiV₃O₈, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, selenium or iodine, iron(III) fluoride, copper(II) fluoride, lithium iodide, active materials based on carbon such as graphite, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials when compatible with each other.

According to one embodiment, the positive electrode electrochemically active material is in the form of particles which are optionally coated (e.g. with polymer, ceramic, carbon, or a combination of two or more thereof).

According to another embodiment, the positive electrode material further comprises an electronically conductive material, for example, comprising at least one of carbon blacks (e.g., Ketjenblack™ or Super P™), acetylene blacks (e.g., Shawinigan black in Denka™ black), graphite, graphene, carbon fibers or nanofibers (for example, vapor grown carbon fibers (VGCFs)), carbon nanotubes (for example, single-walled (SWNT), multi-walled (MWNT)) or metal powders.

In some embodiments, the positive electrode material further comprises a binder, for example, the binder is a polymer as defined above, or a binder selected from rubber-type binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene), and combinations thereof), optionally comprising an additive such as CMC (carboxymethylcellulose). According to other embodiments, the positive electrode material further comprises a salt, inorganic particles of ceramic or glass type, or other compatible active materials (e.g., sulfur), and/or the positive electrode material further comprises the composite material herein defined.

In another embodiment, the negative electrode of the electrochemical cell comprises a negative electrode electrochemically active material.

According to one embodiment, the negative electrode electrochemically active material comprises a metal film comprising an alkali or alkaline earth metal. For example, the metal film comprises lithium comprising less than 1000 ppm (or less than 0.1% by mass) of impurities. Alternatively, the metal film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel, and germanium (e.g., Zr, Cu, Ag, Bi, Co, Zn, Al, Si, Sn, Sb, Cd, Hg, Pb, Mn, B, In, TI, Ni, or Ge), the alloy preferably comprising at least 75% by weight of lithium, or between 85% and 99.9% by weight of lithium.

In another embodiment, the negative electrode electrochemically active material comprises an intermetallic compound (e.g., SnSb, TiSnSb, Cu₂Sb, AlSb, FeSb₂, FeSn₂ and CoSn₂), a metal oxide, metal nitride, metal phosphide, metal phosphate (e.g., LiTi₂(PO₄)₃), metal halide (e.g., metal fluoride), metal sulfide, metal oxysulfide, carbon (e.g., graphite, graphene, reduced graphene oxide, hard carbon, soft carbon, exfoliated graphite and amorphous carbon), silicon (Si), silicon-carbon composite (Si—C), silicon oxide (SiOₓ), silicon oxide-carbon composite (SiOₓ—C), tin (Sn), tin-carbon composite (Sn—C), tin oxide (SnOₓ), tin oxide-carbon composite (SnOₓ—C), and combinations thereof, when compatible. According to another embodiment, the metal oxide is selected from compounds of the formulae M″″_{b}O_{c} (where M″″ is Ti, Mo, Mn, Ni, Co, Cu, V, Fe, Zn, Nb, or a combination thereof; and b and c are numbers such that the c:b ratio is in the range of 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄) and LiM“O (where M′″″ is Ti, Mo, Mn, Ni, Co, Cu, V, Fe, Zn, Nb, or a combination thereof) (e.g., a lithium titanate (such as Li₄Ti₅O₁₂) or a lithium molybdenum oxide (such as Li₂Mo₄O₁₃)).

In some embodiments, the negative electrode electrochemically active material is in the form of particles which are optionally coated (e.g., with polymer, ceramic, carbon, or a combination of two or more thereof).

In one embodiment, the negative electrode material further comprises an electronically conductive material, for example, comprising at least one of carbon blacks (e.g., Ketjenblack™ or Super P™), acetylene blacks (e.g., Shawinigan black in Denka™ black), graphite, graphene, carbon fibers or nanofibers (for example, vapor grown carbon fibers (VGCFs)), carbon nanotubes (for example, single-walled (SWNT), multi-walled (MWNT)) or metal powders.

In another embodiment, the negative electrode material further comprises a binder, for example, the binder is a polymer as defined above, or a binder selected from rubber-type binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene), and combinations thereof), optionally comprising an additive such as CMC (carboxymethylcellulose).

According to yet another embodiment, the negative electrode material further comprises a salt, inorganic particles of the ceramic or glass type, or other compatible active materials, and/or the composite material as herein defined.

According to a fourth aspect, the present technology relates to an electrochemical accumulator comprising at least one electrochemical cell as herein defined. According to one embodiment, the electrochemical accumulator is a lithium battery or a lithium-ion battery.

According to a fifth aspect, the present document relates to the use of an electrochemical accumulator as defined herein, in mobile devices, for example cell phones, cameras, tablets or laptops, in electric or hybrid vehicles, or in renewable energy storage.

According to a last aspect, the present technology also relates to a process for preparing a composite material as herein defined, comprising a step of mixing the inorganic particles, the fluorinated compound, and optionally the polymer. According to one embodiment, the mixing step comprises the polymer and optionally a cross-linking agent. According to another embodiment, the mixing step comprises the polymer and the crosslinking agent, and the process further comprises a polymer crosslinking step.

### BRIEF DESCRIPTION OF THE FIGURES

FIG. 1 shows infrared spectroscopy results for: (a) LATP; (b) NMTFAm; (c) DAEDAm; (d) NMTFAm/LATP mixture; and (e) DAEDAm/LATP mixture.

FIG. 2 shows solid-state NMR results: (a) 1H NMTFAm and NMTFAm/LATP mixture; (b) 6Li LATP; (c) 6Li NMTFAm/LATP mixture.

FIG. 3 shows the Young modulus of the membrane prepared in Example 1(d).

FIG. 4 shows ionic conductivity results as a function of temperature in (a) for Cells 1 to 6 and 8 to 15; and in (b) for Cell 7 in comparison with LATP powder.

FIG. 5 shows the potential as a function of time for Cell 4 cycled at current densities ranging from C/3 to 5C.

FIG. 6 shows electrochemical stability results for Cell 4 carried out at voltages ranging from 3.5 V to 5 V.

FIG. 7 shows the capacity and coulombic efficiency of an NMC/Li cell as a function of the number of cycles according to Example 3(e)(i).

FIG. 8 shows the galvanostatic charge and discharge curves at C/6 of an LFP/Li cell as a function of the number of cycles according to Example 3(e)(ii).

### DETAILED DESCRIPTION

All technical and scientific terms and expressions used herein have the same meaning as that generally understood by the person skilled in the art of the present technology. Definitions of some of the terms and expressions used are nevertheless provided below.

The term “about” as used in this document means approximately, in the region of, and around. When the term “about” is used in connection with a numerical value, it modifies it, for example, above and below by a variation of 10% from the nominal value. This term can also take into account, for example, the experimental error of a measuring device or the rounding of a value.

Where a range of values is mentioned in this application, the lower and upper limits of the range are, unless otherwise specified, always included in the definition.

The chemical structures described here are drawn according to the conventions of the field. Also, when an atom, such as a carbon atom, as drawn appears to include an incomplete valence, then it will be assumed that the valence is satisfied by one or more hydrogen atoms even if they are not explicitly drawn.

The present document presents a composite material comprising inorganic particles, a fluorinated amide and optionally a polymer. Preferably, the fluorinated amide is a compound of Formula I:

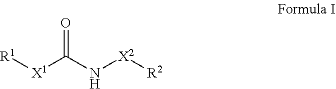

wherein:
R¹ and R² are independently at each occurrence selected from an optionally substituted linear or branched C₁₋₈alkyl group, an optionally substituted C₃₋₈cycloalkyl group, an optionally substituted C₆aryl group, an optionally substituted C₃₋₈heterocycloalkyl group, and an optionally substituted C₅₋₆heteroaryl group;
X¹ is selected from O and NH or X¹ is absent;
X² is selected from C(O), S(O)₂, and Si(R³R⁴), where R³ and R⁴ are independently at each occurrence an optionally substituted linear or branched C₁₋₈alkyl group, or X² is absent;
wherein at least one of R¹, R², R³ and R⁴ is a group substituted by one or more fluorine atoms.

Some examples of compounds of Formula I include compounds wherein:
X¹ is absent, and X² is selected from C(O), S(O)₂, and Si(R³R⁴);
X¹ is selected from O and NH, and X² is absent; or
X¹ and X² are absent.

According to some examples, R¹ is a group substituted with one or more fluorine atoms, for example, R¹ can be a perfluorinated group. This group may be a linear or branched C₁₋₈alkyl group, or a linear or branched C₁₋₄alkyl group, or a C₁₋₂alkyl group.

The R² group may be a group substituted with one or more fluorine atoms, for example, a perfluorinated group. This group may be a linear or branched C₁₋₈alkyl group, or a linear or branched C₁₋₄alkyl group, or a C₁₋₂alkyl group. Alternatively, R² may be an optionally substituted C₃₋₈cycloalkyl group, or an optionally substituted C₃₋₆cycloalkyl group, or an optionally substituted C₅₋₆cycloalkyle group.

Non-limiting examples of fluorinated compounds include compounds N-methyltrifluoroacetamide (NMTFAm), N-methylpentaproprionamide (NMPPPAm), N-cylcopentyltrifluoroacetamide (NCPTFAm), N-trifluoromethylsulfonyl trifluoroacetamide (NTFMSTFAm), N-trimethylsilyl trifluoroacetamide (NTMSTFAm), and bistrifluoroacetamide (BTFAm).

The concentration of the compound in the composite material may be, for instance, within the range of 1% to 90% by weight, or 1% to 70% by weight, or 1% to 50% by weight, or 1% to 40% by weight, or 5% to 30% by weight, or 10% to 25% by weight, or 15% to 20% by weight.

The polymer, when present in the composite material, may comprise at least one polymer segment selected from ionic conducting segments polyether, polythioether, polyester, polythioester, polycarbonate, polythiocarbonate, polyimide, polysulfonimide, polyamide, polysulfonamide, polyphosphazene, or from ionically non-conductive segments polyacrylate, polymethacrylate, polystyrene, polysiloxane, polyurethane, polyethylene, polypropylene, or a copolymer or combination of two or more thereof. The polymer may also be a copolymer comprising the units of two or more of these segments or a combination of two or more of these. The copolymer may be a random copolymer, statistical copolymer, alternating copolymer, block copolymer, etc.

The polymer is preferably a cross-linked aprotic polymer and/or a branched polymer, preferably of the multi-branch type (star configuration, comb configuration, etc.). For example, the polymer comprises at least one polymer segment comprising a block copolymer with at least two different repeating units to reduce the crystallinity of the cross-linked polymer. For instance, the polymer segment may comprise, prior to crosslinking, a block copolymer comprising at least one alkali or alkaline earth metal ion solvating segment and a crosslinkable segment comprising crosslinkable units. An example of an alkali or alkaline earth metal ion solvating segment is selected from homo- and copolymers comprising repeating units of Formula II:

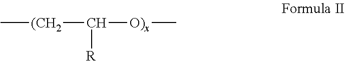

wherein,
R is selected from H, C₁-C₁₀alkyl, and —(CH₂—O—RₐR_{b});
Rₐ is (CH₂—CH₂—O)_{y}; and
R_{b} is a C₁-C₁₀alkyl group.

Non-limiting examples of crosslinkable units comprise functional groups selected from acrylates, methacrylates, allyls, vinyls, hydroxides, epoxides, aldehydes, carboxylic acids, halophenyls, halobenzyls, alkynes, azides, amines, thiols, and any combination thereof. According to another example, the composite material comprises the crosslinked polymer, where the crosslinkable group has been converted into its crosslinked version.

The polymer concentration in the composite material may generally be in the range of 1% to 80% by weight, 5% to 70% by weight, or 10% to 50% by weight, or 20% to 40% by weight.

The inorganic particles preferably comprise an inorganic compound of the amorphous, ceramic or glass-ceramic type, for example, oxide, sulfide or oxysulfide, preferably an oxide. The inorganic compound may be ionically conductive or not, preferably ionically conductive.

Non-limiting example of inorganic compounds comprise the compounds or ceramics Al₂O₃, Mg₂B₂O₅, Na₂O·2B₂O₃, xMgO·yB₂O₃ ZH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., of aluminosilicate, of mesoporous silica), sulfide ceramics (like Li₇P₃S₁₁), glass-ceramics (such as LIPON, etc.), and other ceramics, as well as their combinations, preferably selected from Al₂O₃, Mg₂B₂O₅, Na₂O·2B₂O₃, xMgO·yB₂O₃ ZH₂O, TiO₂, ZrO₂, ZnO, Ti₂O₃, SiO₂, Cr₂O₃, CeO₂, B₂O₃, B2O, SrBi₄Ti₄O₁₅, LLTO, LLZO, LAGP, LATP, Fe₂O₃, BaTiO₃, γ-LiAlO₂, molecular sieves and zeolites (e.g., of aluminosilicate, of mesoporous silica), glass-ceramics (such as LIPON, etc.), as well as their combinations. The inorganic compound is preferably in particulate form, the particles being of various shapes, e.g. in the form of spherical particles, rods, needles, nanotubes, or one of their combinations.

For example, the inorganic particles comprise a compound selected from the compounds of formula Li_{1+z}Al_{z}M_{2-z}(PO₄)₃, where M is Ti, Ge or a combination thereof, and 0<z<1, for example, z can be within the range of 0.1 to 0.9, or of 0.3 to 0.7, or of 0.4 to 0.6, or of 0.2 to 0.5, or of 0.2 to 0.4.

According to other examples, the inorganic particles comprise a compound selected from compounds of the formulae Li₇₋ₓLa₃Zr₂M^{x}ₓO₁₂ and Li_{3y}La_{(2/3)-y}Ti_{1-y′}M^{y}_{y′}O₃ wherein M^{x} is selected from Al, Ga, Ta, Fe, and Nb; M^{y} is selected from Ba, B, Al, Si, and Ta; x is such that 0<x≤ 1; y is such that 0<y<0.67; and y′ is such that 0≤ y′<1, preferably x is within the range of 0 to 0.5, or x is zero and M^{x} is absent, preferably y′ is within the range of 0 to 0.5, or y′ is 0 and M^{y} is absent.

The content of inorganic particles in the composite material may be within the range of 1% to 95% by weight, or of 5% to 90% by weight, or of 5% to 80% by weight, or of 5% to 70% by weight, or of 5% to 60% by weight, or of 5% to 50% by weight, or of 5% to 40% by weight, or of 5% to 25% by weight, or of 5% to 15% by weight.

According to some examples, the composite material comprises the polymer and a plasticizing agent. Non-limiting examples of plasticizing agents include liquids of the glycol diether type (such as tetraethylene glycol dimethyl ether (TEGDME)), carbonate esters, ionic liquids, and the like. When present, the concentration of plasticizing agent in the composite material may be in the range of 0.1% to 50% by weight, or of 10% to 50% by weight, or of 20% to 40% by weight.

According to a preferred example, the composite material further comprises a lithium salt, for example, a salt comprising a cation of an alkali or alkaline earth metal, preferably an alkali metal (preferably Li), and an anion. Non-limiting examples of anions include hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate (TDI⁻), 4,5-dicyano-1,2,3-triazolate (DCTA⁻), bis(pentafluoroethylsulfonyl)imide (BETI⁻), difluorophosphate (DFP⁻), tetrafluoroborate (BF₄⁻), bis(oxalato)borate (BOB⁻), nitrate (NO₃⁻), chloride (Cl⁻), bromide (Br), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato(2⁻)-O,O′)borate [B(C₆O₂)₂]⁻ (BBB⁻), difluoro(oxalato)borate (BF₂(C₂O₄)⁻) (FOB⁻), an anion of the formula BF₂O₄Rₓ⁻ (where Rₓ=C₂₋₄alkyl), and one of their combinations, for example LiTFSI or LiFSI.

The present composite material is prepared according to a process comprising at least a step of mixing inorganic particles, the fluorinated compound, and optionally a polymer and other optional elements as herein described. The mixing step of the process may thus comprise the polymer and optionally a cross-linking agent. The mixing step of such a process can then be followed by a cross-linking step.

The composite material can be incorporated in the composition of a solid electrolyte layer or electrode material.

For example, the electrolyte comprises the composite material as defined herein in a solid layer. This layer can be formed by mixing, in any order, the inorganic particles, the electrolyte polymer or a precursor thereof, the fluorinated amide, and optionally a solvent, plasticizer and/or salt, and coating the mixture on a support. The support may be temporary (such as support of stainless steel, polypropylene, etc.) and removed before assembly with the rest of the electrochemical cell. The support may also be the surface of an electrode material, which will have been prepared beforehand.

When a polymer precursor is used, the coated layer is treated to polymerize or crosslink the polymer, for example, by thermal treatment, irradiation (such as UV, microwave, gamma ray, X-ray, electron beam), or a combination of both, optionally in the presence of an initiator. When a solvent is present, the material is preferably dried, for example, before cross-linking or assembly with the other components of the electrochemical cell.

The present composite material is present in an electrochemical cell in at least one of the electrolyte, the positive electrode or the negative electrode, preferably in the electrolyte layer.

The positive electrode material generally comprises an electrochemically active material and can be self-supported or applied on a current collector. The positive electrode electrochemically active material may, among others, be selected from metal phosphates, lithiated metal phosphates, metal oxides, and lithiated metal oxides.

Examples of electrochemically active materials include LiM′PO₄ where M′ is Fe, Ni, Mn, Co, or a combination thereof, LiV₃O₈, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M″ is Mn, Co, Al, Fe, Cr, Ti, Zr, or a combination thereof), elemental sulfur, selenium or iodine, iron(III) fluoride, copper(II) fluoride, lithium iodide, carbon-based active materials such as graphite, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), IT-conjugated dicarboxylates, and anthraquinone), or a combination of two or more of these materials when compatible with each other.

The positive electrode electrochemically active material is preferably in the form of particles which are optionally coated (e.g. of polymer, ceramic, carbon, or a combination of two or more of these).

The electrode material may also further comprise an electronically conductive material, for example, comprising at least one of carbon blacks (e.g., Ketjenblack™ or Super P™), acetylene blacks (e.g., Shawinigan black in Denka™ black), graphite, graphene, carbon fibers or nanofibers (e.g., vapor grown carbon fibers (VGCFs)), carbon nanotubes (e.g., single-walled (SWNT), multi-walled (MWNT)) or metal powders.

The electrode material may be prepared in the same manner as the electrolyte layer, except that the support for spreading can be the surface of a solid electrolyte layer or a current collector.

When the positive electrode material does not comprise the composite material, it may comprise the electrochemically active material as herein defined, a binder and optionally an electronically conductive material and/or a salt as herein defined.

Non-limiting examples of electrode material binders include the polymers described above in connection with the composite material, but also rubber-type binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene), and combinations thereof). Some binders, such as rubber binders, may also include an additive such as CMC (carboxymethylcellulose).

Other additives may also be present in the positive electrode material, such as inorganic particles like ceramics or glass, or other compatible active materials (e.g. sulfur).

The negative electrode comprises a negative electrode electrochemically active material that may be formed from a metal film, for instance, comprising an alkali or alkaline earth metal. According to one example, the metal film consists of lithium comprising less than 1000 ppm (or less than 0.1% by mass) of impurities. Alternatively, the metal film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel, and germanium (e.g., Zr, Cu, Ag, Bi, Co, Zn, Al, Si, Sn, Sb, Cd, Hg, Pb, Mn, B, In, TI, Ni, or Ge). The alloy may comprise at least 75% by weight of lithium, or between 85% and 99.9% by weight of lithium.

Other examples of negative electrode electrochemically active material include an intermetallic compound (e.g., SnSb, TiSnSb, Cu₂Sb, AlSb, FeSb₂, FeSn₂ and CoSn₂), a metal oxide, metal nitride, metal phosphide, metal phosphate (e.g., LiTi₂(PO₄)₃), metal halide (e.g., metal fluoride), metal sulfide, metal oxysulfide, carbon (e.g., graphite, graphene, reduced graphene oxide, hard carbon, soft carbon, exfoliated graphite and amorphous carbon), silicon (Si), silicon-carbon composite (Si—C), silicon oxide (SiOₓ), silicon oxide-carbon composite (SiOₓ—C), tin (Sn), tin-carbon composite (Sn—C), tin oxide (SnOₓ), tin oxide-carbon composite (SnOₓ—C), and combinations thereof, when compatible. For example, the metal oxide may be selected from compounds of the formulae M″″_{b}O_{c} (where M″″ is Ti, Mo, Mn, Ni, Co, Cu, V, Fe, Zn, Nb, or a combination thereof; and b and c are numbers such that the c:b ratio is in the range of 2 to 3) (e.g., MoO₃, MoO₂, MoS₂, V₂O₅, and TiNb₂O₇), spinel oxides (e.g., NiCo₂O₄, ZnCo₂O₄, MnCo₂O₄, CuCo₂O₄, and CoFe₂O₄) and LiM′″″O (where M′″″ is Ti, Mo, Mn, Ni, Co, Cu, V, Fe, Zn, Nb, or a combination thereof) (e.g., a lithium titanate (such as Li₄Ti₅O₁₂) or a lithium molybdenum oxide (such as Li₂Mo₄O₁₃)).

When the negative electrode is not in the form of a metal film, it rather comprises optionally coated (e.g., with a polymer, ceramic, carbon or a combination of two or more thereof) particles of a negative electrode electrochemically active material.

The negative electrode material may also comprise other components as described for the negative electrode (such as an electronically conductive material, the present composite material, a salt, a binder, inorganic particles of ceramic or glass type, or other compatible active materials).

The present document also pertains to an electrochemical accumulator comprising at least one electrochemical cell as herein defined. For example, the electrochemical accumulator is a lithium or lithium-ion battery.

According to a fifth aspect, the use electrochemical accumulators of the present application are intended for use in mobile devices, for example cell phones, cameras, tablets or laptops, in electric or hybrid vehicles, or in renewable energy storage.

### EXAMPLES

The following examples are for illustrative purposes and should not be interpreted as limiting the scope of the invention as described.

Unless otherwise specified, numbers expressing component quantities, preparatory conditions, concentrations, properties, etc. used herein are to be interpreted as modified at each instance by the term “about”. At the very least, each numerical parameter should be interpreted in the light of the number of significant digits reported, and by the application of usual rounding techniques. Therefore, unless otherwise indicated, the numerical parameters mentioned here are approximations that may vary depending on the properties sought. Nevertheless, although the parameters defining the broadest embodiments are approximations, the numerical values presented in the following examples are reported as precisely as possible. Any numerical value, however, inherently contains a certain margin of error resulting from variations in experiments, measurements, statistical analyses, etc.

The crosslinkable polymers used in the following examples are polyethers comprising crosslinkable units, as described in U.S. Pat. No. 7,897,674 (hereinafter referred to as “polymer US′674”, which is a branched multibranch-type polymer comprising crosslinkable units) or in U.S. Pat. No. 6,903,174 (hereinafter referred to as “polymer US′174”, which is linear and comprises crosslinkable pendant groups).

### Example 1-Preparation of Electrolytes

### (a) Polymer Electrolyte (Comparative)

2 g of lithium bis(trifluoromethanesulfonyl)imide (LiTFSI), 8 g of polymer US′674 and 0.08 g of Irgacure™ are mixed in a flask at room temperature. Once a homogeneous solution has been obtained, the solution is coated on a thin stainless-steel sheet. After UV irradiation under nitrogen for 3 minutes, the solid polymer electrolyte membrane is thus obtained.

(b) Composite Electrolyte with HNT and DAEDAm (Comparative)

0.5 g of LiTFSI, 0.77 g of tetraethylene glycol dimethyl ether (TEGDME), 0.25 g of N,N′-diacetylethylenediamine (DAEDAm) and 0.24 g of Halloysite nanotubes (HNT) are thoroughly mixed in a flask at room temperature. Once a homogeneous dispersion has been obtained, 0.75 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(c) Composite Electrolyte with HNT and NMTFAm

0.5 g of LiTFSI, 0.69 g of TEGDME, 0.44 g of N-methyltrifluoroacetamide (NMTFAm) and 0.26 g of HNT are thoroughly mixed in a flask at room temperature. Once a homogeneous dispersion has been obtained, 0.67 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(d) Composite Electrolyte with LATP and NMTFAm

0.5 g of LiTFSI, 0.77 g of TEGDME, 0.44 g of NMTFAm, and 0.26 g of Li_{1,3}Al_{0,3}Ti_{1,7}(PO₄)₃ (LATP) are thoroughly mixed in a flask at room temperature. Once a homogeneous dispersion has been obtained, 0.67 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(e) Composite Electrolyte with LATP and DAEDAm (Comparative)

0.5 g of LiTFSI, 0.77 g of TEGDME, 0.25 g of DAEDAm and 0.24 g of LATP are thoroughly mixed in a flask at room temperature. Once a homogeneous dispersion has been obtained, 0.75 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(f) Polymer Electrolyte with NMTFAm (Comparative)

0.5 g of LiTFSI, 0.77 g of TEGDME, and 0.25 g of NMTFAm are thoroughly mixed in a flask at room temperature. Once a homogeneous solution has been obtained, 0.99 g of polymer US′674 and 0.01 g of Irgacure™ are added. After stirring for 1 hour at room temperature, the solution is coated on a thin stainless-steel sheet. The polymer electrolyte membrane thus obtained is cured by UV irradiation under nitrogen for 3 minutes.

(g) Ceramic Electrolyte with LATP and NMTFAm

0.35 g of LATP and 0.15 g of NMTFAm are thoroughly mixed and ground in a mortar at room temperature. Then, the powder is compressed into a round pellet at a pressure of 120 psi, with a diameter of 16 mm and a thickness of 420 μm. A comparative sample with pure LATP powder was also prepared in the same way.

(h) Composite Electrolyte with LLZO and NMTFAm 0.5 g of LiTFSI, 0.77 g of TEGDME, 0.44 g of NMTFAm and 0.26 g of LizLasZr₂O₁₂ (LLZO) are thoroughly mixed in a flask at room temperature. Once a homogeneous dispersion has been obtained, 0.67 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.
(i) Composite Electrolyte with LATP, NMTFAm and Polymer US′174

0.5 g of LiTFSI, 0.77 g of TEGDME, 0.44 g of NMTFAm and 0.26 g of LATP are thoroughly mixed in a flask at room temperature. Once a homogeneous dispersion has been obtained, 0.67 g of polymer US′174 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(j) Composite Electrolyte with LATP and NMPPPAm

0.5 g of LiTFSI, 0.77 g of TEGDME, 0.44 g of N-methylpentaproprionamide (NMPPPAm) and 0.26 g of LATP are thoroughly mixed in a flask at room temperature. Once a homogeneous dispersion has been obtained, 0.67 g of polymer US′674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(k) Composite Electrolyte with LATP and NCPTFAm

0.5 g of LiTFSI, 0.77 g of TEGDME, 0.44 g of N-cylcopentyltrifluoroacetamide (NCPTFAm) and 0.26 g of LATP are thoroughly mixed in a flask at room temperature. Once a homogeneous dispersion has been obtained, 0.67 g of polymer US'674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(l) Composite Electrolyte with LATP and NTFMSTFAm

0.5 g of LiTFSI, 0.77 g of TEGDME, 0.44 g of N-trifluoromethylsulfonyl trifluoroacetamide (NTFMSTFAm) and 0.26 g of LATP are thoroughly mixed in a flask at room temperature. Once a homogeneous dispersion has been obtained, 0.67 g of polymer US'674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(m) Composite Electrolyte with LATP and NTMSTFAm

0.5 g of LiTFSI, 0.77 g of TEGDME, 0.44 g of N-trimethylsilyl trifluoroacetamide (NTMSTFAm) and 0.26 g of LATP are thoroughly mixed in a flask at room temperature. Once a homogeneous dispersion has been obtained, 0.67 g of polymer US'674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(N) Composite Electrolyte with LATP and BTFAm

0.5 g of LiTFSI, 0.77 g of TEGDME, 0.44 g of bistrifluoroacetamide (BTFAm) and 0.26 g of LATP are thoroughly mixed in a flask at room temperature. Once a homogeneous dispersion has been obtained, 0.67 g of polymer US'674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

(o) Composite Electrolyte with LATP and Less NMTFAm

0.5 g of LiTFSI, 0.65 g of TEGDME, 0.37 g of 1,1′-hexamethylene bis(1-methylpyrrolidinium) bis(trifluoromethanesulfonyl)imide, 0.11 g of NMTFAm and 0.26 g of LATP are thoroughly mixed in a flask at room temperature. Once a homogeneous dispersion has been obtained, 0.60 g of polymer US'674 and 0.01 g of Irgacure™ are added. After stirring for 1 hour at room temperature, the dispersion is coated on a thin stainless-steel sheet. The composite electrolyte membrane thus obtained is cured by UV irradiation under nitrogen for 3 minutes.

### Example 2-Physicochemical Properties

### (a) Infrared Spectroscopy of the Particle-Amide Mixture

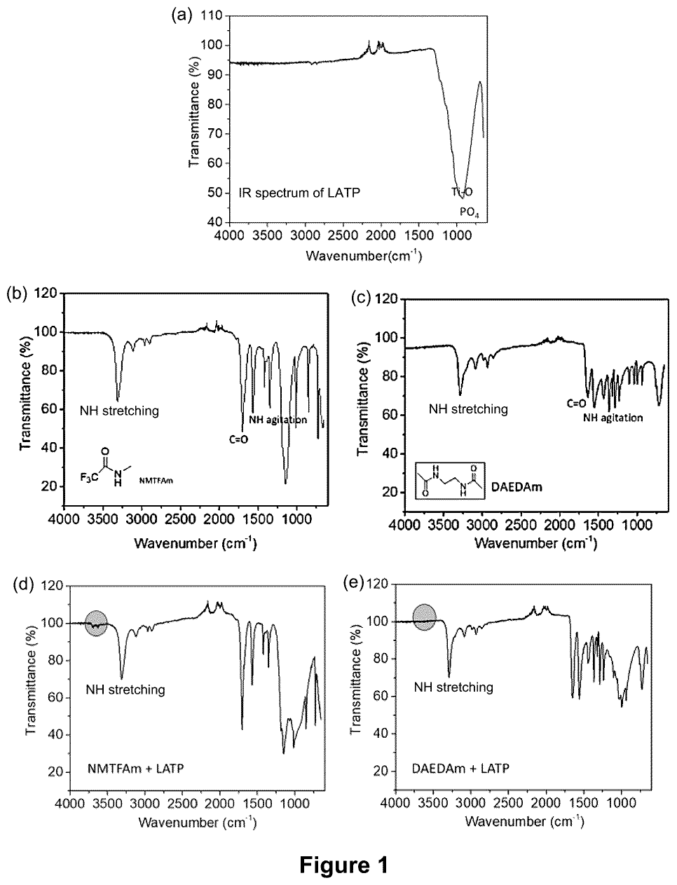

In order to better understand the effect of the presence of the fluorinated amide, chemical analyses were carried out. Solid-state infrared spectroscopy was performed on an Agilent-Cary 630® FTIR spectrometer. Particle-amide mixtures were prepared with a 1.7:1 weight ratio for NMTFAm/LATP and a 1:1 weight ratio for DAEDAm/LATP by grinding in a mortar. Infrared spectra of LATP, NMTFAm, DAEDAm, and of the LATP/NMTFAm and LATP/DAEDAm mixtures are shown in FIGS. 1(a) to (e).

FIG. 1(d) shows that a new signal appeared at around 3550 cm⁻¹ for the LATP/NMTFAm mixture, which was absent in the case of LATP/DAEDAm in FIG. 1(e). This new signal indicates that there is an interaction between the fluorinated amide and the LATP ceramic, this interaction not being present in the case of the non-fluorinated amide DAEDAm.

### (b) NMR Chemical Structure of the NMTFAm/LATP Mixture

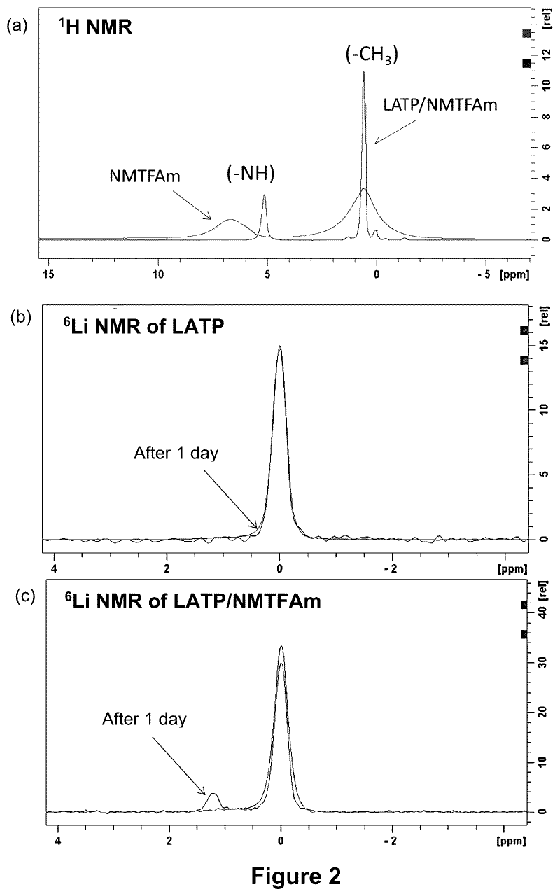

To confirm the results observed by infrared spectroscopy, solid NMR analyses of NMTFAm and the NMTFAm/LATP mixture were carried out on a 500 MHz NMR spectrometer equipped with a 4 mm triple resonance probe with MAS (magic angle spinning), up to 15 kHz. The NMTFAm/LATP mixture was prepared as described in 2(a). 1H and 6Li NMR spectra of NMTFAm, LATP, and of the NMTFAm/LATP mixture are shown in FIGS. 2(a) to (c).

FIG. 2(a) shows that the NMTFAm signals are broader than those of the NMTFAm/LATP mixture, indicating an interaction between NMTFAm and LATP that significantly reduces the restriction of molecular mobility in NMTFAm. In addition, a shift of the peak corresponding to NMTFAm NH protons towards a higher frequency may indicate that more NH protons in the mixture are involved in hydrogen bonding.

FIG. 2(c) shows that an additional signal at 1.2 ppm appeared in the 6Li NMR spectra of the mixture after a 1 day storage compared with FIG. 2(b), indicating that new Lit ions were generated by the interaction between NMTFAm and LATP.

### (c) Young Modulus of the Membrane

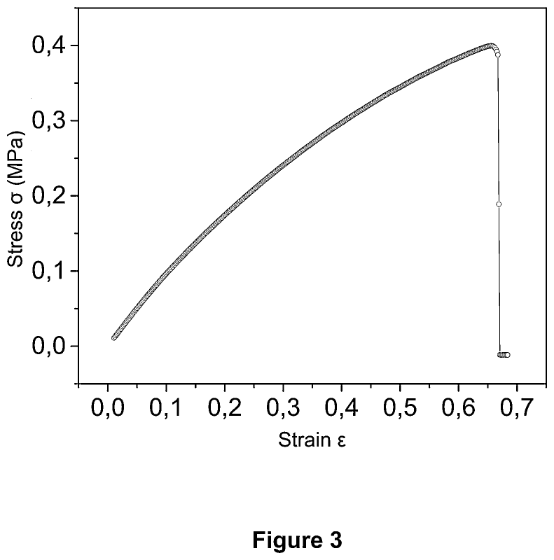

The Young modulus was evaluated for the membrane prepared in Example 1(d) on a TA Discovery DMA850 at 20° C. The film size for measurement was 10.7 mm×5.3 mm×0.167 mm (length×width×thickness). The Rate Control Strain Ramp procedure was used. FIG. 3 shows a graph of the Young modulus of the membrane prepared in Example 1(d).

### (d) Diffusion Coefficient

The ionic diffusion coefficients of the various elements of the membrane prepared in Example 1(d) were evaluated by pulsed field gradient solid-state NMR spectroscopy of the ¹H, ⁷Li, and ¹⁹F nuclei. NMR experiments were carried out on a 500 MHz NMR spectrometer equipped with a Diff50™ probe and dual-resonance ⁷Li-¹⁹F and ¹H-¹⁹F RF inserts.

Measurements were carried out at 25° C. and 50° C. The gradient pulse ranged from 0.6 to 2.0 ms and the diffusion time was in range of 40 to 100 ms depending on the nucleus. Gradient strength was varied in 16 steps from 100 G/cm to 2500 G/cm.

Diffusion measurements were accompanied T2 relation experiments using a CPMG pulse sequence with an echo delay of 0.06 to 0.6 ms. Up to 64 echoes were collected per experiment. The results are presented in Table 1.

TABLE 1
Diffusion coefficients measured by NMR spectroscopy

| | | | | | | Li in |
|---|---|---|---|---|---|---|
| | Polymer | NMTFAm | NMTFAm | TFSI⁻ | Li⁺ | LATP |
| Temp. | (m²/s) | ¹H (m²/s) | ¹⁹F (m²/s) | (m²/s) | (m²/s) | (m²/s) |
| 50° C. | 3.1 × 10⁻¹³ | 3.8 × 10⁻¹¹ | 3.7 × 10⁻¹¹ | 1.7 × 10⁻¹¹ | 1.1 × 10⁻¹¹ | 5.7 × 10⁻¹² |
| 25° C. | 5.7 × 10⁻¹⁴ | 1.4 × 10⁻¹¹ | 1.4 × 10⁻¹¹ | 6.6 × 10⁻¹² | 4.7 × 10⁻¹² | 2.9 × 10⁻¹² |

Most of the species were highly mobile in the sample, enabling higher resolution of the NMR spectra.

The diffusion coefficients of NMTFAm measured from 1H and 19F NMR are in perfect agreement with each other.

The diffusion coefficients of Li in LATP at 25 and 50° C. match the values obtained with other LATP-containing samples. This observation confirms that lithium diffusion in LATP is not dependent on the polymer surrounded LATP particles, especially considering that the mean square displacement of the species during the NMR experiment is around 0.5 to 1 μm (much smaller than the LATP particle size which is around 10 μm).

### Example 3-Electrochemical Properties

### (a) Cell Assembly (Symmetrical Batteries)

Symmetrical coin cells of Li/Electrolyte/Li type for critical current density (CCD) measurement and of Stainless steel/Electrolyte/Stainless steel type for ionic conductivity measurement were assembled. Polymer electrolyte membrane disks were cut to a diameter of 16 mm (for the ionic conductivity measurement) of a diameter of 14 mm (for the CCD measurement) and pressed between two electrodes. The configuration of each cell is presented as follows:
Cell 1: Electrode/Example 1(a)/Electrode
Cell 2: Electrode/Example 1(b)/Electrode
Cell 3: Electrode/Example 1(c)/Electrode
Cell 4: Electrode/Example 1(d)/Electrode
Cell 5: Electrode/Example 1(e)/Electrode
Cell 6: Electrode/Example 1(f)/Electrode
Cell 7: Electrode/Example 1(g)/Electrode
Cell 8: Electrode/Example 1(h)/Electrode
Cell 9: Electrode/Example 1(i)/Electrode
Cell 10: Electrode/Example 1(j)/Electrode
Cell 11: Electrode/Example 1(k)/Electrode
Cell 12: Electrode/Example 1(I)/Electrode
Cell 13: Electrode/Example 1(m)/Electrode
Cell 14: Electrode/Example 1(n)/Electrode
Cell 15: Electrode/Example 1(o)/Electrode
Electrode=Metal lithium or stainless steel

### (b) Ionic Conductivity

Electrochemical impedance spectroscopy was performed with a Bio-Logic® VMP-300 system at an amplitude of 100 mV and a frequency range of 1 MHz to 200 mHz.

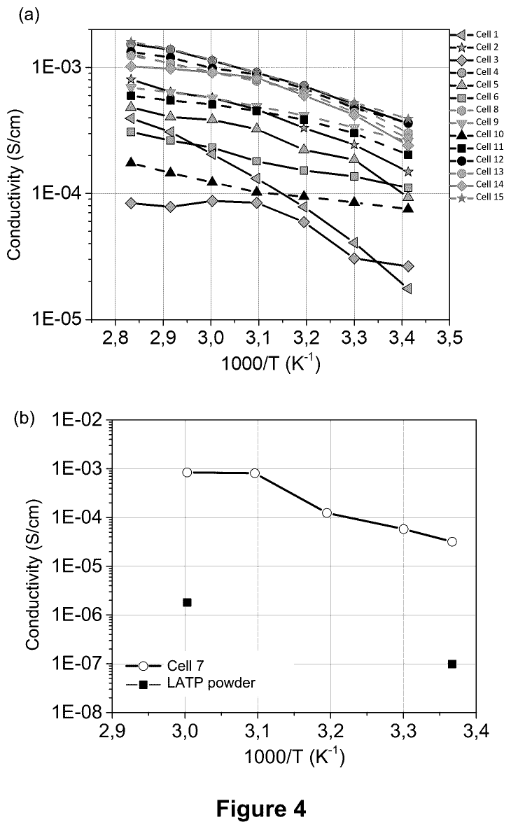

FIGS. 4(a) and 4(b) show ionic conductivity results for Cells 1 to 15. Conductivity results at 50° C. and 25° C. are also shown in Table 2 below.

It can be seen, for instance, that the ionic conductivity in the LATP/fluorinated amide electrolyte (NMTFAm, 3.62×10⁻⁴ S/cm) at 20° C. is much higher than that of LATP/non-fluorinated amide (DAEDAm, 9.29×10⁻⁵ S/cm) and of Halloysite nanotubes/NMTFAm (2.64×10⁻⁵ S/cm). Ionic conductivity at 20° C. is also generally higher for all electrolytes comprising a fluorinated amide compared with the electrolyte without fluorinated amide.

### (c) Critical Current Density

Critical current density was assessed using a Bio-Logic® VMP-3 system. The test starts at a current density of C/24 (1C=3.0 mA/cm²), increasing progressively. The same current density was applied to charge and discharge the battery.

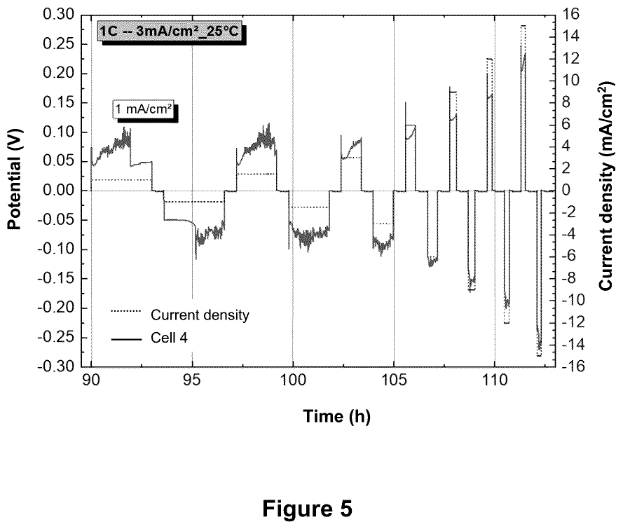

FIG. 5 shows that Cell 4, a symmetrical Li/electrolyte/Li cell with the LATP/NMTFAm electrolyte from Example 1(d), is stable up to 5C (1C=3.0 mA/cm²) at 25° C. The results are also summarized in Table 2 below.

TABLE 2
Electrolyte composition (weight %) and results for Cells 1 to 15

| | | | | | | Conductivity | | |
|---|---|---|---|---|---|---|---|---|
| | | | | | | (×10⁻⁴ S/cm) | | CCD |
| | LiTFSI | Polymer^{a} | TEGDME | Additive | Ceramic | at | at | at |
| # | (%) | (%) | (%) | (%) | (%) | 50° C. | 25° C. | 25° C. |
| 1 | 20 | 80 | 0 | 0 | 0 | 1.35 | 0.163 | C/6 |
| 2 | 20 | 30 | 30 | 10 | 10 | 4.66 | 1.14 | C/3 |
| | | | | DAEDAm | HNT | | | |
| 3 | 20 | 26 | 27 | 17 | 10 | 0.842 | 0.264 | 1 C |
| | | | | NMTFAm | HNT | | | |
| 4 | 20 | 26 | 27 | 17 | 10 | 9.08 | 3.62 | 5 C |
| | | | | NMTFAm | LATP | | | |
| 5 | 20 | 30 | 30 | 10 | 10 | 4.0 | 0.929 | C/3 |
| | | | | DAEDAm | LATP | | | |
| 6 | 20 | 36 | 27 | 17 | 0 | 2.1 | 1.1 | C/2 |
| | | | | NMTFAm | | | | |
| 7 | 0 | 0 | 0 | 30 | 70 | 8.1 | 0.32 | NM^{b} |
| | | | | NMTFAm | LATP | | | |
| 8 | 20 | 26 | 27 | 17 | 10 | 7.8 | 4.01 | NM^{b} |
| | | | | NMTFAm | LLZO | | | |
| 9 | 20 | 26 | 27 | 17 | 10 | 4.93 | 3.04 | C/12 |
| | | | | NMTFAm | LATP | | | |
| 10 | 20 | 26 | 27 | 17 | 10 | 1.02 | 0.801 | C/2 |
| | | | | NMPPPAm | LATP | | | |
| 11 | 20 | 26 | 27 | 17 | 10 | 4.54 | 2.61 | 1 C |
| | | | | NCPTFAm | LATP | | | |
| 12 | 20 | 26 | 27 | 17 | 10 | 8.8 | 4.15 | C/2 |
| | | | | NTFMSTFAm | LATP | | | |
| 13 | 20 | 26 | 27 | 17 | 10 | 8.01 | 3.67 | C/2 |
| | | | | NTMSTFAm | LATP | | | |
| 14 | 20 | 26 | 27 | 17 | 10 | 8.3 | 3.3 | C/2 |
| | | | | BTFAm | LATP | | | |
| 15^{c} | 20 | 24 | 26 | 5 | 10 | 9.78 | 4.13 | 1 C |
| | | | | NMTFAm | LATP | | | |

^{a}Polymer US′674 except for Cell 9, where polymer US′174 was used.
^{b}NM: not-measured
^{c}The electrolyte also comprises 15% by weight of 1,1′-hexamethylene bis(1-methylpyrrolidinium) bis(trifluoromethanesulfonyl)imide.

### (d) Electrochemical Stability

To assess the electrochemical stability of the membrane prepared in Example 1(d), a solution with 20% by weight carbon black (Ketjenblack™) was prepared.

0.5 g of LiTFSI, 0.77 g of TEGDME, 0.44 g of NMTFAm and 0.26 g of Li_{1,3}Al_{0,3}Ti_{1,7}(PO₄)₃ (LATP) were thoroughly mixed in a flask at room temperature. Once a homogeneous dispersion has been obtained, 0.67 g of polymer US'674, 0.01 g of azobisisobutyronitrile and a dispersion of 0.528 g of carbon black is 6 mL of acetonitrile were added. After stirring for 1 hour at room temperature with a planetary centrifugal mixer, the dispersion was coated onto a conductive carbon-coated aluminum foil. The solvent was then evaporated under vacuum at 40° C., then the membrane was placed in an oven at 100° under nitrogen for 10 min. A layer of the electrolyte from Example 1(a) or Example 1(d) was coated onto the carbon membrane. The electrolyte layer is cured by UV irradiation under nitrogen for 3 minutes. The complete membrane for electrochemical stability measurement is thus obtained.

To assemble coin cells, membrane disks were cut with a diameter of 16 mm. The electrolyte side is covered with a lithium foil. The cells thus formed are named Cell 8 and Cell 9, comprising the membranes of Examples 1(a) and 1(d) respectively.

Electrochemical stability was evaluated using a Bio-Logic® VMP-3 system. Voltage varied from 3.5 V to 5 V, with an increase rate of 0.1 V every 2 hours.

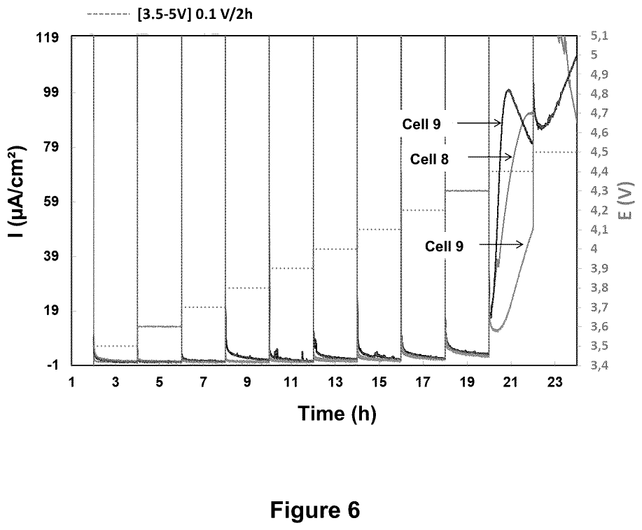

FIG. 6 shows the electrochemical stability for Cell 9, comprising the membrane prepared in Example 1(d), and for Cell 8, comprising the membrane prepared in Example 1(a).

In summary, it can be observed that the addition of N-methyltrifluoroacetamide (NMTFAm) to a composite electrolyte based on polymer US'674 and LATP (a phosphate-type oxide ceramic) can greatly improve ionic conductivity and stability at the Li/electrolyte interface (see FIG. 1) at 25° C., with oxidation stability reaching up to 4.5V. This observation is confirmed by the ionic conductivity and critical current density (CCD) in symmetrical cells comprising the electrolyte compared with other ceramics or amide.

### (e) Assembly and Performance of Complete Cells

Complete cells using the electrolyte of Example 1(d) were assembled their performance was evaluated.

### (i) Cell NMC811/Electrolyte/Li

A cathode was prepared as described in patent application PCT/CA2022/050159 by including 73.2% by weight of lithiated nickel manganese cobalt oxide (NMC811) active material, giving a loading rate of approximately 8 mg/cm². The electrolyte dispersion of Example 1(d) was directly coated on the cathode and cured by UV irradiation under nitrogen for 3 minutes. The electrolyte thickness is approximately 40 μm. A lithium metal foil with a thickness of 50 μm was used as the anode. A 3.8 cm² coin cell was assembled to evaluate performance.

The performance evaluation was carried out on a Bio-Logic BCS-810 system with a voltage of 2.75-4.2 V and a charge-discharge rate of C/6-1C (1C=1.2 mA/cm²) at 45° C. Cell capacity is around 4.4 mAh (1.2 mAh/cm²).

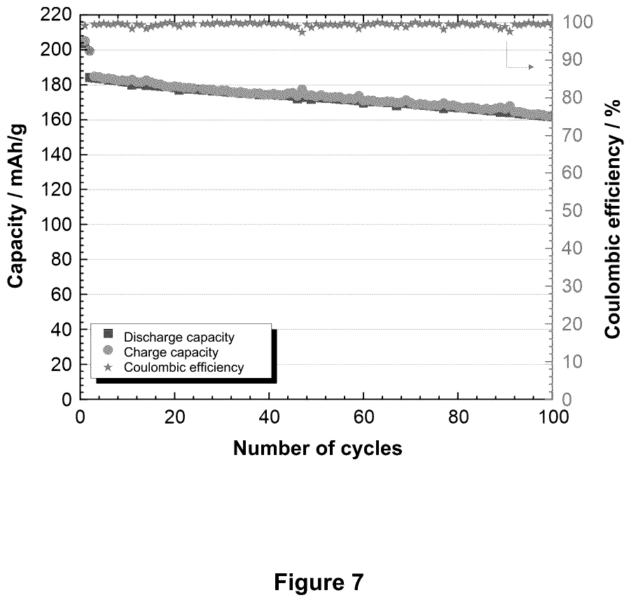

FIG. 7 shows cell capacity and coulombic efficiency as a function of the number of cycles.

### (ii) Cell LFP/Electrolyte/Li

A LiFePO4 (LFP) cathode was prepared as in Example 3(e)(i) by replacing NMC811 with LFP as the active material at a concentration by weight of 70%, giving a loading rate of approximately 12 mg/cm². The electrolyte dispersion of Example 1(d) was directly coated on the cathode and cured by UV irradiation under nitrogen for 3 minutes. The electrolyte thickness is approximately 40 μm. A lithium metal foil with a thickness of 40 μm was used as the anode. A 3.8 cm² coin cell was assembled to evaluate the performance.

Performance evaluation was carried out on a Bio-Logic BCS-810 system with a voltage 2-3.8 V and a charge-discharge rate C/6-C/6 (1C=1.2 mA/cm²) at 45° C. Cell capacity is of about 3 mAh (0.8 mAh/cm²).

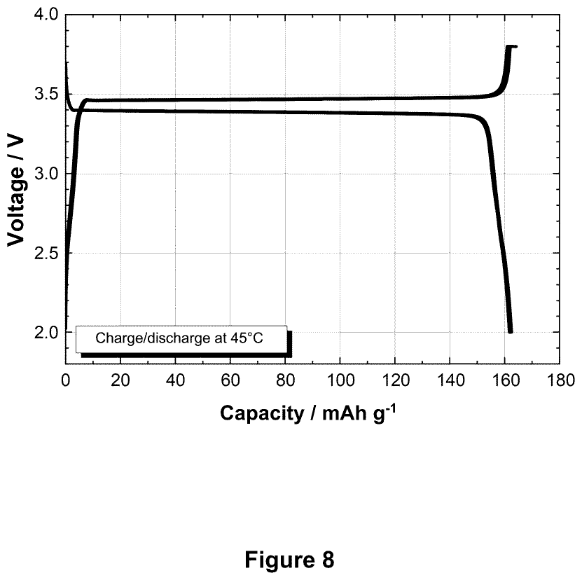

FIG. 8 shows the galvanostatic charge and discharge curves at a charging and discharging rate of C/6.

Numerous modifications could be made to any of the embodiments above without departing from the scope of the present invention as contemplated. The references, patents or scientific literature documents referred to in the present application are incorporated herein by reference in their entirety for all purposes.

What is claimed is:

1. Composite material comprising inorganic particles, a fluorinated compound, and optionally a polymer, wherein the fluorinated compound is of Formula I: 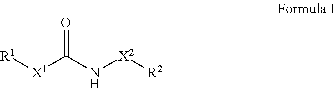
wherein:
R¹ and R² are independently at each occurrence selected from an optionally substituted linear or branched C₁₋₈alkyl group, an optionally substituted C₃₋₈cycloalkyl group, an optionally substituted C₆aryl group, an optionally substituted C₃₋₈heterocycloalkyl group, and an optionally substituted C₅₋₆heteroaryl group;
X¹ is selected from O and NH or X¹ is absent;
X² is selected from C(O), S(O)₂, and Si(R³R⁴), where R³ and R⁴ are independently at each occurrence an optionally substituted linear or branched C₁₋₈alkyl group, or X² is absent;
wherein at least one of R¹, R², R³ and R⁴ is a group substituted by one or more fluorine atoms.

2. Composite material of claim 1, wherein:
X¹ is absent and X² is selected from C(O), S(O)₂, and Si(R³R⁴); or
X¹ is selected from O and NH, and X² is absent; or
X¹ and X² are absent.

3. (canceled)

4. (canceled)

5. Composite material of claim 1, wherein R¹ is a group substituted by one or more fluorine atoms, preferably R¹ is a perfluorinated group, and/or R¹ is a linear or branched C₁₋₈alkyl group, or a linear or branched C₁₋₄alkyl group, or a C₁₋₂alkyl group.

6. (canceled)

7. (canceled)

8. Composite material of claim 1, wherein R² is a group substituted by one or more fluorine atoms, preferably is a perfluorinated group; and/or R² is a linear or branched C₁₋₂alkyl group, or a linear or branched C₁₋₄alkyl group, or a C₁₋₂alkyl group, or an optionally substituted C₃₋₈cycloalkyl group, or an optionally substituted C₃₋₆cycloalkyl group, or an optionally substituted C₅₋₆cycloalkyle group.

9. (canceled)

10. (canceled)

11. (canceled)

12. Composite material of claim 1, wherein the compound is selected from N-methyltrifluoroacetamide (NMTFAm), N-methylpentaproprionamide (NMPPPAm), N-cylcopentyltrifluoroacetamide (NCPTFAm), N-trifluoromethylsulfonyl trifluoroacetamide (NTFMSTFAm), N-trimethylsilyl trifluoroacetamide (NTMSTFAm), and bistrifluoroacetamide (BTFAm).

13. Composite material of claim 1, wherein the concentration of the compound in the composite material is within the range of 1% to 90% by weight, or 1% to 70% by weight, or 1% to 50% by weight, or 1% to 40% by weight, or 5% to 30% by weight, or 10% to 25% by weight, or 15% to 20% by weight.

14. Composite material of claim 1, wherein the polymer is present, the polymer preferably being a cross-linked aprotic polymer and/or a branched polymer, preferably of the multi-branch type.

15. (canceled)

16. (canceled)

17. Composite material of claim 14, wherein the polymer comprises at least one polymer segment selected from ionic conducting segments polyether, polythioether, polyester, polythioester, polycarbonate, polythiocarbonate, polyimide, polysulfonimide, polyamide, polysulfonamide, polyphosphazene, and the ionically non-conductive segments polyacrylate, polymethacrylate, polystyrene, polysiloxane, polyurethane, polyethylene, polypropylene, or a copolymer or combination of two or more thereof.

18. Composite material of claim 14, wherein the polymer comprises at least one polymer segment comprising a block copolymer with at least two different repeating units in order to reduce the crystallinity of the crosslinked polymer, preferably the polymer segment comprises, prior to crosslinking, a block copolymer comprising at least one alkali or alkaline earth metal ion solvating segment and a crosslinkable segment comprising crosslinkable units, preferably wherein:
the alkali or alkaline earth metal ion solvating segment is selected from homo- and copolymers comprising repeating units of Formula II: 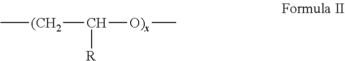
wherein,
R is selected from H, C₁-C₁₀alkyl, and —(CH)₂—O—RₐR_{b});
Rₐ is (CH₂—CH₂—O)_{y}; and
R_{b} is a C₁-C₁₀alkyl group; and/or
the crosslinkable units comprise functional groups selected from acrylates, methacrylates, allyls, vinyls, hydroxides, epoxides, aldehydes, carboxylic acids, halophenyls, halobenzyls, alkynes, azides, amines, thiols and any combination thereof.

19. (canceled)

20. (canceled)

21. (canceled)

22. Composite material of claim 14, wherein the polymer is present in the composite material at a concentration in the range of 1% to 80% by weight, 5% to 70% by weight, or 10% to 50% by weight, or 20% to 40% by weight.

23. Composite material of claim 1, wherein the inorganic particles comprise an inorganic compound of the amorphous, ceramic or glass-ceramic type, for example, oxide, sulfide or oxysulfide, preferably the inorganic compound of the amorphous, ceramic or glass-ceramic type being an oxide.

24. (canceled)

25. Composite material of claim 1, wherein the inorganic particles comprise a ceramic selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B2O, SrBi₄Ti₄O₁₅, LLTO, LLZO, LAGP, LATP, Fe₂O₃, BaTiO₃, γ-LiAlO₂, molecular sieves and zeolites (e.g., of aluminosilicate, of mesoporous silica), sulfide ceramics (such as Li₇P₃S₁₁), glass ceramics (e.g. LIPON, etc.), and other ceramics, as well as combinations thereof, preferably selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, molecular sieves and zeolites (e.g., aluminosilicate, mesoporous silica), glass ceramics (e.g. LIPON, etc.), and combinations thereof.

26. (canceled)

27. Composite material of claim 1, wherein the inorganic particles are in the form of spherical particles, rods, needles, nanotubes, or one of their combinations.

28. Composite material of claim 1, wherein the inorganic particles comprise:
a compound selected from the compounds of formula:
Li_{1+z}Al_{z}M_{2-z}(PO₄)₃
wherein M is Ti, Ge or a combination thereof, and z is such that 0<z<1, preferably z is in the range of 0.1 to 0 9, or of 0.3 to 0.7, or of 0.2 to 0.4; or
a compound select from compounds of formulae:
Li₇₋ₓLa₃Zr₂M^{z}ₓO₁₂ and Li_{3y}La_{(2/3)-y}Ti_{1-y}M^{y}_{y}O₃
wherein:
M^{z} is selected from Al, Ga, Ta, Fe and Nb;
M^{y} is selected from Ba, B, Al, Si, and Ta;
x is SU that 0≤x≤1;
y is such that 0≤y<0.67; and
y′ is such that 0≤y′<1;
preferably x being in the range of 0 to 0.5, preferably x is zero and M^{x} is absent.

29. (canceled)

30. (canceled)

31. (canceled)

32. Composite material of claim 1, wherein the inorganic particle content is in the range from 1% to 95% by weight, or from 5% to 90% by weight, or from 5% to 80% by weight, or from 5% to 70% by weight, or from 5% to 60% by weight, or from 5% to 50% by weight, or from 5% to 40% by weight, or from 5% to 25% by weight, or from 5% to 15% by weight.

33. Composite material of claim 1, wherein the polymer is present, and the composite material further comprises a plasticizing agent, preferably selected from liquids of the type glycol diethers (such as tetraethylene glycol dimethyl ether (TEGDME)), carbonate esters, ionic liquids, and the like, preferably the plasticizing agent being present in the composite material at a concentration in the range of 0.1% to 50% by weight, or of 10% to 50% by weight, or of 20% to 40% by weight.

34. (canceled)

35. (canceled)

36. Composite material of claim 1, further comprising a salt, preferably the salt comprises a cation of an alkali or alkaline earth metal, preferably an alkali metal (preferably Li), and an anion selected from the anions hexafluorophosphate (PF₆⁻), bis(trifluoromethanesulfonyl)imide (TFSI⁻), bis(fluorosulfonyl)imide (FSI⁻), (flurosulfonyl)(trifluoromethanesulfonyl)imide ((FSI)(TFSI)⁻), 2-trifluoromethyl-4,5-dicyanoimidazolate dicyanoimidazolate (TDI⁻), 4,5-dicyano-1,2,3-triazolate (DCTA⁻), bis(pentafluoroethylsulfonyl)imidure (BETI⁻), difluorophosphate (DFP⁻), tetrafluoroborate (BF₄⁻), bis(oxalato)borate (BOB⁻), nitrate (NO₃⁻), chloride (Cl⁻), bromide (Br⁻), fluoride (F⁻), perchlorate (ClO₄⁻), hexafluoroarsenate (AsF₆⁻), trifluoromethanesulfonate (SO₃CF₃⁻) (Tf⁻), fluoroalkylphosphate [PF₃(CF₂CF₃)₃⁻] (FAP⁻), tetrakis(trifluoroacetoxy)borate [B(OCOCF₃)₄]⁻ (TFAB⁻), bis(1,2-benzenediolato(2-)-O,O′)borate [B(C₆O₂)₂]⁻ (BBB⁻), difluoro(oxalato)borate (BF₂(C₂O₄)⁻) (FOB⁻), an anion of the formula BF₂O₄Rₓ⁻ (where Rₓ═C₂₋₄alkyl), and one of their combinations, for example LiTFSI or LiFSI.

37. (canceled)

38. Solid electrolyte comprising a layer of the composite material as defined in claim 1.

39. Electrochemical cell comprising a negative electrode, a positive electrode, and a solid electrolyte, wherein at least one of the positive electrode, the negative electrode, and the electrolyte comprises a composite material as defined in claim 1.

40. Electrochemical cell comprising a negative electrode, a positive electrode, and a solid electrolyte, wherein the solid electrolyte is as defined in claim 38.

41. (canceled)

42. Electrochemical cell of claim 39, wherein the positive electrode comprises a positive electrode material optionally on a current collector, wherein the positive electrode material comprises a positive electrode electrochemically active material, preferably the positive electrode electrochemically active material being selected from metal phosphates, lithiated metal phosphates, metal oxides, and lithiated metal oxides; or the positive electrode electronically active material is LiM″PO₄ where M′ is Fe, Ni, Mn, Co, or a combination thereof, LiV₃O₈, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=₁), Li(NiM′″)O₂ (where M′″ is Mn, Co, Al, Fe, Cr, Ti, Zr, or a combination thereof), elemental sulfur, selenium or iodine, iron(III) fluoride, copper(II) fluoride, lithium iodide, active materials based on carbon such as graphite, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials when compatible with each other.

43. (canceled)

44. (canceled)

45. Electrochemical cell of claim 42, wherein the positive electrode electrochemically active material is in the form of particles which are optionally coated (e.g. with polymer, ceramic, carbon, or a combination of two or more thereof).

46. Electrochemical cell of claim 42, wherein the positive electrode material further comprises an electronically conductive material, for example, comprising at least one of carbon blacks (e.g., Ketjenblack™ or Super P™), acetylene blacks (e.g., Shawinigan black in Denka™ black), graphite, graphene, carbon fibers or nanofibers (for example, vapor grown carbon fibers (VGCFs)), carbon nanotubes (for example, single-walled (SWNT), multi-walled (MWNT)) or metal powders; and/or the positive electrode material further comprises a binder preferably the binder is a polymer as herein defined, or a binder selected from rubber-type binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene), and combinations thereof), optionally comprising an additive such as CMC (carboxymethylcellulose).

47. (canceled)

48. (canceled)

49. Electrochemical cell of claim 42, wherein the positive electrode material further comprises a salt, inorganic particles of ceramic or glass type, or other compatible active materials (e.g., sulfur), and/or wherein iv de material further comprises the composite material as defined herein.

50. (canceled)

51. Electrochemical cell of claim 39, wherein the negative electrode comprises a negative electrode electrochemically active material.

52. Electrochemical cell of claim 51, wherein the negative electrode electrochemically active material comprises a metal film comprising an alkali or alkaline earth metal, the metal film preferably comprising:
lithium comprising less than 1000 ppm (or less than 0.1% by mass) of impurities; or
an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese zinc, aluminum, silicon, tin, antimony, cadmium, mercury, lead, molybdenum, iron, boron, indium, thallium, nickel, and germanium (e.g., Zr, Cu, Ag, Bi, Co, Zn, Al, Si, Sn, Sb, Cd, Hg, Pb, Mn, B, In, Tl, Ni, or Ge), the alloy preferably comprising at least 75% by weight of lithium, or between 85% and 99.9% by weight of lithium.

53. (canceled)

54. (canceled)

55. (canceled)

56. Electrochemical cell of claim 51, wherein the negative electrode electrochemically active material comprises an intermetallic compound (e.g., SnSb, TiSnSb, Cu₂Sb, AlSb, FeSb₂, FeSn₂ and CoSn₂), a metal oxide, a metal nitride, a metal phosphide, a metal phosphate (e.g., LiTi₂(PO₄)₃), a metal halide (e.g., metal fluoride), a metal sulfide, a metal oxysulfide, a carbon (e.g., graphite, graphene, reduced graphene oxide, hard carbon, soft carbon, exfoliated graphite and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and combinations thereof, when compatible, the metal oxide preferably being selected from compounds of the formulae M″″_{b}O_{c} (where M″″ is Ti, Mo, Mn, Ni, Co, Cu, V, Fe, Zn, Nb, or a combination thereof; and b and c are numbers such that the c-b ratio is in the range of ₂ to ₃) (e.g., MoO₃, MoO₂, MoS₂, V₂O₅, and TiNb₂O₇), spinel oxides (e.g., NiCo₂O₄), ZnCo₂O₄, MnCo₂O₄, CuCo₂O₄, and CoFe₂O₄) and LiM′″″O (where M′″″ is Ti, Mo, Mn, Ni, Co, Cu, V, Fe, Zn, Nb, or a combination thereof) (e.g., a lithium titanate (such as Li₄Ti₅O₁₂) or a lithium molybdenum oxide (such as Li₂Mo₄O₁₃)).

57. (canceled)

58. Electrochemical cell of claim 56, wherein the negative electrode electrochemically active material is in the form of particles which are optionally coated (e.g., with polymer, ceramic, carbon, or a combination of two or more thereof).

59. Electrochemical cell of claim 58, wherein the negative electrode material further comprises an electronically conductive material, for example, comprising at least one of carbon blacks (e.g., Ketjenblack™ or Super P™), acetylene blacks (e.g., Shawinigan black in Denka™ black), graphite, graphene, carbon fibers or nanofibers (for example, vapor grown carbon fibers (VGCFs)), carbon nanotubes (for example, single-walled (SWNT), multi-walled (MWNT)) or metal powders, and/or the negative electrode material further comprises a binder, preferably the binder is a polymer as defined herein, or a binder selected from rubber-type binders (such as SBR (styrene-butadiene rubber), NBR (acrylonitrile-butadiene rubber), HNBR (hydrogenated NBR), CHR (epichlorohydrin rubber), ACM (acrylate rubber)), or fluorinated polymer-type binders (such as PVDF (polyvinylidene fluoride), PTFE (polytetrafluoroethylene), and combinations thereof), optionally comprising an additive such as CMC (carboxymethylcellulose).

60. (canceled)

61. (canceled)

62. Electrochemical cell of claim 58, wherein the negative electrode material further comprises a salt, inorganic particles of the ceramic or glass type, or other compatible active materials; and/or the negative electrode material further comprises the composite material defined herein.

63. (canceled)

64. Electrochemical accumulator comprising at least one electrochemical cell as defined in claim 39, preferably said electrochemical accumulator is a lithium battery or a lithium-ion battery.

65. (canceled)

66. (canceled)

67. Process for preparing a composite material as defined in claim 1, comprising a step of mixing the inorganic particles, the fluorinated compound, and optionally the polymer, the mixing step preferably comprising the polymer and optionally a cross-linking agent, preferably the mixing step comprises the crosslinking agent, and the process further comprises a polymer crosslinking step.

68. (canceled)

69. (canceled)
